(19) United States
(12) Patent Application Publication
(10) Pub. No.: US 2026/0282055 A1
(43) Pub. Date: Sep. 17, 2026

(54) MULTIPLE PSFCH TRANSMISSIONS ON AN UNLICENSED SPECTRUM

(71) Applicant: LENOVO (BEIJING) LIMITED, Beijing (CN)

(72) Inventors: Zhennian SUN, Beijing (CN); Haipeng LEI, Beijing (CN); Xiaodong YU, Beijing (CN); Xin GUO, Beijing (CN)

(21) Appl. No.: 19/469,054

(22) PCT Filed: Jul. 19, 2023
(86) PCT No.: PCT/CN2023/108241

§ 371 Date: Sep. 25, 2025

(51) Int. Cl. H04W 72/40; H04W 52/36; H04W 72/02; H04W 72/563

(52) U.S. Cl. CPC H04W 72/40; H04W 52/367; H04W 72/02; H04W 72/563

(57) ABSTRACT

Embodiments of the present disclosure relate to multiple physical sidelink feedback channel (PSFCH) transmissions on an unlicensed spectrum. In some embodiments, a user equipment (UE) selects, from a first set of physical sidelink feedback channels (PSFCHs) to be transmitted on a transmission occasion, a second set of PSFCHs. A first PSFCH of the first set of PSFCHs occupies a common interlace and a first set of physical resource blocks (PRBs) dedicated to the first PSFCH. A second PSFCH of the second set of PSFCHs is associated with part or all of PRBs of the common interlace and a second set of PRBs dedicated to the second PSFCH. The second set of PRBs comprises one or more PRBs of the first set of PRBs. Moreover, the UE transmits the second set of PSFCHs. In this way, it is possible to improve the flexibility of the PSFCH transmissions and thus improve sidelink communication efficiency.

### TECHNICAL FIELD

The present disclosure relates to wireless communications, and more specifically to multiple physical sidelink feedback channel (PSFCH) transmissions on an unlicensed spectrum.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

With the development of communication technologies, several technologies have been proposed. In third generation partnership project (3GPP) release 16 (Rel-16), hybrid automatic repeat request (HARQ) feedback on a PSFCH was introduced to achieve sidelink unicast and groupcast communications. In 3GPP release 18 (Rel-18), HARQ feedback for the sidelink transmission on an unlicensed spectrum is a suitable way to achieve the high reliability of sidelink communications. However, enhancements on the PSFCH transmission on the unlicensed spectrum are still needed.

### SUMMARY

The present disclosure relates to apparatuses and methods that support multiple

PSFCH transmissions on an unlicensed spectrum. With the apparatuses and methods, it is possible to improve the flexibility of the PSFCH transmissions and thus improve sidelink communication efficiency.

In a first aspect, there is provided a terminal device (UE). The UE comprises at least one memory; and at least one processor coupled with the at least one memory and configured to cause the UE to: select, from a first set of physical sidelink feedback channels (PSFCHs) to be transmitted on a transmission occasion, a second set of PSFCHs, wherein a first PSFCH of the first set of PSFCHs occupies a common interlace and a first set of physical resource blocks (PRBs) dedicated to the first PSFCH, and a second PSFCH of the second set of PSFCHs is associated with part or all of PRBs of the common interlace and a second set of PRBs dedicated to the second PSFCH, the second set of PRBs comprising one or more PRBs of the first set of PRBs; and transmit the second set of PSFCHs.

In a second aspect, there is provided a method performed by the UE. The method comprises: selecting, from a first set of physical sidelink feedback channels (PSFCHs) to be transmitted on a transmission occasion, a second set of PSFCHs, wherein a first PSFCH of the first set of PSFCHs occupies a common interlace and a first set of physical resource blocks (PRBs) dedicated to the first PSFCH, and a second PSFCH of the second set of PSFCHs is associated with part or all of PRBs of the common interlace and a second set of PRBs dedicated to the second PSFCH, the second set of PRBs comprising one or more PRBs of the first set of PRBs; and transmitting the second set of PSFCHs.

In a third aspect, there is provided a processor for wireless communication. The at least one processor comprises at least one controller coupled with at least one memory and configured to cause the at least one processor to: select, from a first set of physical sidelink feedback channels (PSFCHs) to be transmitted on a transmission occasion, a second set of PSFCHs, wherein a first PSFCH of the first set of PSFCHs occupies a common interlace and a first set of physical resource blocks (PRBs) dedicated to the first PSFCH, and a second PSFCH of the second set of PSFCHs is associated with part or all of PRBs of the common interlace and a second set of PRBs dedicated to the second PSFCH, the second set of PRBs comprising one or more PRBs of the first set of PRBs; and transmit the second set of PSFCHs.

In some implementations of the method and the UE described herein, the at least one processor is further configured to cause the UE to: determine transmitting power for the second set of PSFCHs, and transmitting the second set of PSFCH comprises: transmitting the second set of PSFCH based on the transmitting power.

In some implementations of the method and the UE described herein, determining the transmitting power for the second set of PSFCHs comprises: performing power control for one or more PRBs associated with and dedicated to the second set of PSFCHs, based on a first parameter on maximum transmitting power for the one or more PRBs associated with and dedicated to the second set of PSFCHs; and the at least one processor is further configured to cause the UE to: perform power control for one or more PRBs of the common interlace, based on a second parameter on maximum transmitting power for the common interlace. In some implementations of the method and the UE described herein, the maximum transmitting power for the common interlace is distributed to part or all of PRBs within the common interlace, the part of PRBs comprising one or more PRBs determined to be transmitted within the common interlace.

In some implementations of the method and the UE described herein, determining the transmitting power for the second set of PSFCHs comprises: performing power control for one or more PRBs associated with and dedicated to the second set of PSFCHs and one or more PRBs of the common interlace, based on a third parameter on an offset of maximum transmitting power between the common interlace and the one or more PRBs associated with and dedicated to the second set of PSFCHs. In some implementations of the method and the UE described herein, a value of the offset is in a level of a resource block (RB), or in a level of a total number of RBs.

In some implementations of the method and the UE described herein, determining the transmitting power for the second set of PSFCHs comprises: equally distributing transmitting power among one or more PRBs determined to be transmitted within the common interlace and one or more PRBs associated with and dedicated to the second set of PSFCHs.

In some implementations of the method and the UE described herein, the at least one processor is further configured to cause the UE to: determine the second set of PRBs based on bandwidth information of the second PSFCH.

In some implementations of the method and the UE described herein, determining the second set of PRBs comprises: dropping, from the first set of PRBs, a candidate PRB, based on determining that the candidate PRB locates within a bandwidth threshold with a PRB, determined to be transmitted, dedicated to a target PSFCH of the second set of PSFCHs. In some implementations of the method and the UE described herein, selecting the second set of PSFCHs comprises: during a selection associated with the first PSFCH of the first set of PSFCHs, based on determining that all one or more PRBs of the first set of PRBs are dropped, dropping the first PSFCH.

In some implementations of the method and the UE described herein, determining the second set of PRBs comprises: determining a minimum number of PRBs required for the second PSFCH; and determining the second set of PRBs based on the minimum number of PRBs.

In some implementations of the method and the UE described herein, determining the second set of PRBs comprises: dropping one or more PRBs from the first set of PRBs, until a number of remaining PRBs of the first set of PRBs is the minimum number of PRBs. In some implementations of the method and the UE described herein, determining the second set of PRBs comprises: dropping one or more PRBs from the first set of PRBs, if a number of remaining PRBs of the first set of PRBs is not less than the minimum number of PRBs. In some implementations of the method and the UE described herein, dropping the one or more PRBs from the first set of PRBs comprises: dropping, from the first set of PRBs, a candidate PRB, based on determining that the candidate PRB locates within a bandwidth threshold with a PRB, determined to be transmitted, dedicated to a target PSFCH of the second set of PSFCHs. In some implementations of the method and the UE described herein, dropping the one or more PRBs from the first set of PRBs comprises: dropping, from the first set of PRBs, a candidate PRB, based on determining that: the candidate PRB locates within a bandwidth threshold with a PRB, determined to be transmitted, dedicated to a first target PSFCH of the second set of PSFCHs; and a total number of PRBs, of the first set of PRBs, locating within the bandwidth threshold with one or more PRBs, determined to be transmitted, dedicated to one or more target PSFCHs of the second set of PSFCHs exceeds a maximum number threshold.

In some implementations of the method and the UE described herein, the minimum number of PRBs required for the second PSFCH is determined based on measured reference signal received power (RSRP) of a physical sidelink control channel (PSCCH) or a physical sidelink shared channel (PSSCH) associated with the second PSFCH.

In some implementations of the method and the UE described herein, selecting the second set of PSFCHs comprises: during a selection associated with the first PSFCH of the first set of PSFCHs, adding the first PSFCH to the second set of PSFCHs, based on determining that a total number of PRBs, of the first set of PRBs, locating within a bandwidth threshold with one or more PRBs, determined to be transmitted, dedicated to one or more target PSFCHs of the second set of PSFCHs fail to exceed a maximum number threshold.

In some implementations of the method and the UE described herein, selecting the second set of PSFCHs comprises: during a selection associated with the first PSFCH of the first set of PSFCHs, dropping the first PSFCH, based on determining that a total number of PRBs, of the first set of PRBs, locating within a bandwidth threshold with one or more PRBs, determined to be transmitted, dedicated to one or more target PSFCHs of the second set of PSFCHs exceeds a maximum number threshold. In some implementations of the method and the UE described herein, the selection from the first set of PSFCHs is performed based on an order of priorities associated with PSFCHs of the first set of PSFCHs, wherein selecting the second set of PSFCHs further comprises one of the following: stopping a selection procedure for the second set of PSFCHs and transmitting one or more selected PSFCHs of the PSFCHs; or continuing a selection associated with a further PSFCH associated with a next priority after a priority of the first PSFCH.

In some implementations of the method and the UE described herein, the maximum number threshold is configured, or pre-configured or pre-defined.

In some implementations of the method and the UE described herein, the second PSFCH is associated with the part of PRBs of the common interlace in a case where a PRB of the common interlace is excluded based on determining that the PRB of the common interlace and one or more PRBs of the first set of PRBs locate within a bandwidth threshold.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

FIG. 1A illustrates an example of a wireless communications system that supports multiple PSFCH transmissions on an unlicensed spectrum in accordance with aspects of the present disclosure;

FIG. 1B illustrates an example PSFCH occupation associated with aspects of the present disclosure;

FIG. 2 illustrates a flowchart of a method that supports multiple PSFCH transmissions on an unlicensed spectrum in accordance with aspects of the present disclosure;

FIG. 3 illustrates an example of a device that supports multiple PSFCH transmissions on an unlicensed spectrum in accordance with aspects of the present disclosure; and

FIG. 4 illustrates an example of a processor that supports multiple PSFCH transmissions on an unlicensed spectrum in accordance with aspects of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s).

Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As mentioned above, in Rel-18, HARQ feedback for sidelink transmission on an unlicensed spectrum is a suitable way to achieve the high reliability of sidelink communications. The support of sidelink on an unlicensed spectrum has been discussed as follows.

| 1. | Study and specify support of sidelink on an unlicensed spectrum for both mode 1 and | |
|---|---|---|
| | mode 2 where Uu operation for mode 1 is limited to licensed spectrum only [RAN1, | |
| | RAN2, RAN4] | |
| | - | Channel access mechanisms from NR-U shall be reused for sidelink unlicensed |
| | | operation |

| | |
|---|---|
| ∘ | Assess the applicability of sidelink resource reservation from Rel-16/Rel- |
| | 17 to sidelink unlicensed operation within the boundaries of unlicensed |
| | channel access mechanism and operation |

| | |
|---|---|
| ▪ | No specific enhancements for Rel-17 resource allocation |
| | mechanisms |
| ▪ | If the existing NR-U channel access framework does not support the |
| | required SL-U functionality, WGs will make appropriate |
| | recommendations for RAN approval. |

| | |
|---|---|
| - | Physical channel design framework: Required changes to NR sidelink physical |
| | channel structures and procedures to operate on an unlicensed spectrum |

| | |
|---|---|
| ∘ | The existing NR sidelink and NR-U channel structure shall be reused as the |
| | baseline. |

| | |
|---|---|
| - | No specific enhancements for existing NR SL feature |
| - | The study should focus on FR1 unlicensed bands (n46 and n96/n102) and is to |
| | be completed by RAN#98. |

For the PSFCH transmission in sidelink, a UE may have to transmit multiple PSFCHs in a PSFCH transmission occasion to the same UE or different UEs. Moreover, in sidelink, a UE may receive multiple PSSCHs from the same UE or different UEs, and the associated PSFCHs may be located in the same PSFCH transmission occasion.

Simultaneous PSFCH transmissions/receptions have been specified, for example, in the technical specification (TS) 38.213 as follows.

```
16.2.4.2 Simultaneous PSFCH transmission/reception
If a UE
  - would transmit N_{sch,Tx,PSFCH} PSFCHs and receive N_{sch,Rx,PSFCH} PSFCHs, and
  - transmissions of the N_{sch,Tx,PSFCH} PSFCHs would overlap in time with receptions
    of the N_{sch,Rx,PSFCH}
the UE transmits or receives only a set of PSFCHs corresponding to the smallest priority
field value, as determined by a first set of SCI format 1-A and a second set of SCI format
1-A [5, TS 38.212] that are respectively associated with the N_{sch,Tx,PSFCH} PSFCHs and
the N_{sch,Rx,PSFCH} PSFCHs.
If a UE would transmit N_{sch,Tx,PSFCH} PSFCHs in a PSFCH transmission occasion, the UE
transmits N_{Tx,PSFCH} PSFCHs corresponding to the smallest N_{Tx,PSFCH} priority field
values indicated in all SCI formats 1-A associated with the PSFCH transmission occasion.
16.2.3 PSFCH
A UE with N_{sch,Tx,PSFCH} scheduled PSFCH transmissions, and capable of transmitting a
maximum of N_{max,PSFCH} PSFCHs, determines a number N_{Tx,PSFCH} of simultaneous
PSFCH transmissions and a power P_{PSFCH,k}(i) for a PSFCH transmission k, 1 ≤ k ≤
N_{Tx,PSFCH}, on a resource pool in PSFCH transmission occasion i on active SL BWP b of
carrier f as
  - if dl-P0-PSFCH is provided,
              P_{PSFCH,one} = P_{O,PSFCH} + 10 log₁₀(2^{μ}) + α_{PSFCH} · PL [dBm]
    where
    - P_{O,PSFCH} is a value of dl-P0-PSFCH
    - α_{PSCH} is a value of dl-Alpha-PSFCH, if provided; else, α_{PFSCH} = 1
        - PL = PL_{b,f.c}(q_{d}) when the active SL BWP is on a serving cell c, as
          described in clause 7.1.1 except that
          - the RS resource is the one the UE uses for determining a power of a
            PUSCH transmission scheduled by a DCI format 0_0 in serving cell c
            when the UE is configured to monitor PDCCH for detection of DCI
            format 0_0 in serving cell c
          - the RS resource is the one corresponding to the SS/PBCH block the UE
            uses to obtain MIB when the UE is not configured to monitor PDCCH for
            detection of DCI format 0_0 in serving cell c
    - if N_{sch,Tx,PSFCH} ≤ N_{max,PSFCH}
        - if P_{PSFCH,one} + 10log₁₀(N_{sch,Tx,PSFCH}) ≤ P_{CMAX}, where P_{CMAX} is
          determined for N_{sch,Tx,PSFCH} PSFCH transmissions according to [8-1, TS
          38.101-1]
          - N_{Tx,PSFCH} = N_{sch,Tx,PSFCH} and P_{PSFCH,k}(i) = P_{PSFCH,one} [dBm]
        - else
          - UE autonomously determines N_{Tx,PSFCH} PSFCH transmissions with
            ascending order of corresponding priority field values as described in
            $clause 16.2 \text{.4} \text{.2} such that {N}_{Tx , PSFCH} \geq max ( 1 , {\sum }_{i = 1}^{K} {M}_{i} ) where {M}_{i} is a$
            number of PSFCHs with priority value i and K is defined as
            $‐ the largest value satisfying {P}_{P S F CH , one} + 10 {log}_{10} ( max ( 1 , {\sum }_{i = 1}^{K} {M}_{i} ) ) \leq$
              P_{CMAX} where P_{CMAX} is determined according to [8-1, TS 38.101-1]
              for transmission of all PSFCHs assigned with priority values 1, 2, ... ,
              K, if any
            - zero, otherwise
            and
          P_{PSFCH,k}(i) = min(P_{CMAX} − 10log₁₀(N_{Tx,PSFCH}), P_{PSFCH, one}) [dBm]
          where P_{CMAX} is defined in [8-1, TS 38.101-1] and is determined for the
          N_{Tx,PSFCH} PSFCH transmissions
    - else
      - the UE autonomously selects N_{max,PSFCH} PSFCH transmissions with
          ascending order of corresponding priority field values as described in clause
          16.2.4.2
          - if P_{PSFCH,one} + 10log₁₀(N_{max,PSFCH}) ≤ P_{CMAX}, where P_{CMAX} is
            determined for the N_{max,PSFCH} PSFCH transmissions according to [8-1,
            TS 38.101-1]
            - N_{Tx,PSFCH} = N_{max,PSFCH} and P_{PSFCH,k}(i) = P_{PSFCH},ₒₙₑ [dBm]
          - else
            - the UE autonomously selects NTx,PSFCH PSFCH transmissions in
                ascending order of corresponding priority field values as described in
                $clause 16.2 \text{.4} \text{.2} such that {N}_{Tx , PSFCH} \geq max ( 1 , {\sum }_{i = 1}^{K} {M}_{i} ) where {M}_{i} is a$
                number of PSFCHs with priority value i and K is defined as
                - the largest value satisfying P_{PSFCH,one} +
                  $10 {log}_{10} ( max ( 1 , {\sum }_{i = 1}^{K} {M}_{i} ) ) \leq {P}_{CMAX} where {P}_{CMAX} is determined$
                  according to [8-1, TS 38.101-1] for transmission of all PSFCHs
                  assigned with priority values 1, 2, ... , K, if any
                - zero, otherwise
                and
          P_{PSFCH,k}(i) = min(P_{CMAX} − 10log₁₀(N_{Tx,PSFCH}), P_{PSFCH,one}) [dBm]
                where P_{CMAX} is determined for the N_{Tx,PSFCH} simultaneous PSFCH
                transmissions according to [8-1, TS 38.101-1]
- else
                P_{PSFCH,k}(i) = P_{CMAX} − 10log₁₀(N_{Tx,PSFCH}) [dBm]
  where the UE autonomously determines N_{Tx,PSFCH} PSFCH transmissions with
  ascending order of corresponding priority field values as described in clause
  16.2.4.2 such that N_{Tx,PSFCH} ≥ 1 and where P_{CMAX} is determined for the
  N_{Tx,PSFCH} PSFCH transmissions according to [8-1, TS 38.101-1].
```

As described above, the PSFCH transmissions in the same PSFCH transmission occasion are limited by the UE capability. For example, the maximum number of PSFCH transmissions on the same occasion may be (pre-) configured per UE, and if the number of

PSFCH transmissions is beyond the UE capability, the UE may select a set of PSFCHs for transmission with consideration of priorities associated with the PSFCHs and transmitting power.

In the last 3GPP RAN #1 meeting, two alternatives on the structure of the PSFCH for sidelink on the unlicensed spectrum (SL-U) were agreed as follows.

Agreement
Regarding PSFCH transmission with 15 kHz and 30 kHz SCS:

| • | One of the following alternatives is (pre-)configured: | |
|---|---|---|
| | ∘ | Alt 1-1b: each PSFCH transmission occupies 1 common interface and K3 |
| | | dedicated PRB(s) |

| | |
|---|---|
| ▪ | K3 is (pre-)configured |

| | |
|---|---|
| • | Value range for K3 at least includes {1, 2, 5} |

| | |
|---|---|
| ▪ | K3 dedicated PRB(s) are on the same interlace |
| ▪ | There can be some guardband PRB(s) between common PRB and |
| | dedicated PRB |

| | |
|---|---|
| • | FFS details, e.g., whether/how to derive the number of |
| | guardband PRB(s), whether to additionally introduce a |
| | (pre-)configured gap (including 0), or whether this can be |
| | satisfied by (pre-)configuration and there is no additional |
| | specification impact (e.g., setting proper bit values in |
| | bitmap for PSFCH PRB allocation), etc. |
| • | FFS whether to additionally introduce guardband RE |
| | between common PRB and dedicated PRB |

| | |
|---|---|
| ▪ | On the K3 dedicated PRB(s), multiple CS pairs can be used as in |
| | legacy NR SL PSFCH transmission |
| ▪ | When a PRB of common interlace and a dedicated PRB locate |
| | within the same 1 MHz bandwidth, UE only transmits on the |
| | dedicated PRB subject to meeting OCB requirements |
| ▪ | FFS: whether to reduce power on common PRBs |

| | |
|---|---|
| ∘ | Alt 2-3a: each PSFCH transmission occupies 1 dedicated interlace |

| | |
|---|---|
| • | PSSCH transmissions on non-overlapped resources are mapped to orthogonal |
| | dedicated PRBs for PSFCH transmission |
| • | FFS: whether or not to support PRB-level cyclic shift hopping as in NR-U to |
| | reduce PAPR |
| • | FFS: whether to drop common PRBs if the dedicated PRBs can already satisfy |
| | OCB requirement |

In SL-U, to meet the occupied channel bandwidth (OCB) requirement, the above Alt 1-1b is agreed to introduce one common interlace for the OCB requirement for each PSFCH. With the legacy power control mechanism of PSFCH, the transmitting power is equally distributed among multiple PSFCHs. Thus for the PSFCH structure Alt 1-1b, the common interlace is shared by multiple PSFCH transmissions if the legacy power control mechanism is applied, and thus, when multiple UEs transmit multiple PSFCHs, the total transmitting power for the common interlace will be much higher than that for the dedicated PRBs. The in-band emission (IBE) issue of the common interlace will reduce the reliability of the PSFCH whose dedicated PRBs locate closely to the PRBs of the common interlace. One solution is to introduce the guardband PRB(s) between the PRBs of common interlace and the dedicated PRBs, however, this will reduce the number of dedicated PRBs and the capacity of the PSFCH.

Moreover, regulation on power spectral density (PSD) is required for the operation on an unlicensed spectrum. For example, with the PSD requirement, the transmitting power of each 1 MHz bandwidth shall not be larger than 10 dBm. As a UE may transmit multiple PSFCHs in a PSFCH transmission occasion, the dedicated PRBs of different PSFCHs may also locate within the same 1 MHz bandwidth. Thus, PSD requirement shall be also considered for this case, for example, for the selection of simultaneous PSFCH transmissions.

In view of the above, as of now, there is no effective way to support multiple PSFCH transmissions in a PSFCH transmission occasion on the unlicensed spectrum. Therefore, there is a need for an improved solution for the multiple PSFCH transmissions. Especially, there is a need to enhance the power control of multiple PSFCH transmissions and the selection of simultaneous PSFCH transmissions.

Embodiments of the present disclosure provide a solution for multiple PSFCH transmissions on the unlicensed spectrum. In one aspect of the solution of the present disclosure, a UE selects, from a first set of PSFCHs to be transmitted on a transmission occasion, a second set of PSFCHs. A first PSFCH of the first set of PSFCHs occupies a common interlace and a first set of PRBs dedicated to the first PSFCH, and a second PSFCH of the second set of PSFCHs is associated with part or all of PRBs of the common interlace and a second set of PRBs dedicated to the second PSFCH, the second set of PRBs comprising one or more PRBs of the first set of PRBs. Moreover, the UE transmits the second set of PSFCHs.

By allowing the second PSFCH of the second set of PSFCHs to be associated with a second set of PRBs dedicated to the second PSFCH, which comprises one or more PRBs of the first set of PRBs, this solution allows the associated PRB(s) dedicated to the second set of PSFCHs to be transmitted. In this way, it is possible to improve the flexibility of the selection of the second set of PSFCHs to be transmitted and thus the flexibility of the PSFCH transmissions. Therefore, it is allowed to improve sidelink transmission efficiency.

Principles and implementations of embodiments of the present disclosure will be described in detail below with reference to the figures.

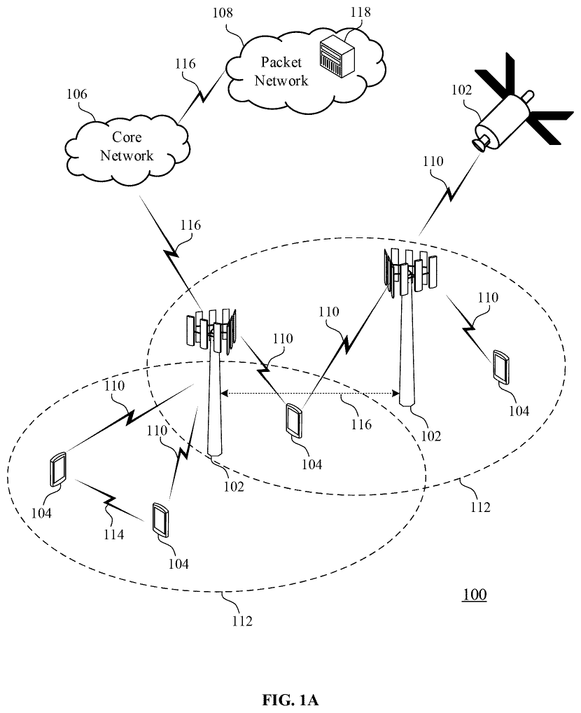

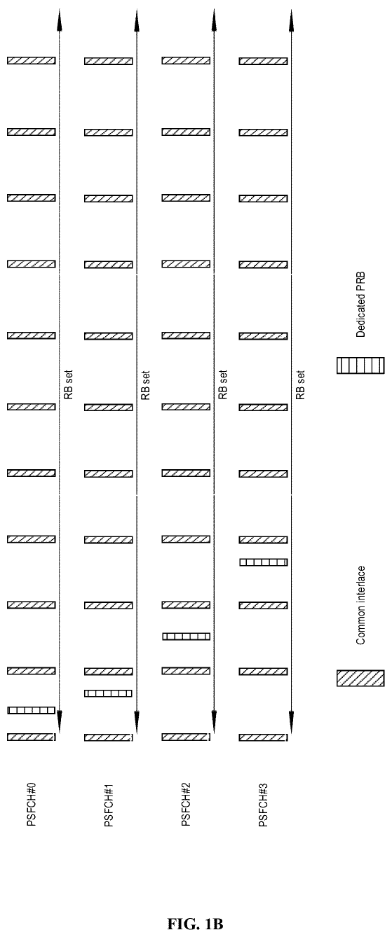

FIG. 1A illustrates an example of a wireless communications system 100 that supports multiple PSFCH transmissions on an unlicensed spectrum in accordance with aspects of the present disclosure. The wireless communications system 100 may include one or more network entities 102 (also referred to as network equipment (NE)), one or more UEs 104, a core network 106, and a packet data network 108. The wireless communications system 100 may support various radio access technologies. In some implementations, the wireless communications system 100 may be a 4G network, such as a long term evolution (LTE) network or an LTE-Advanced (LTE-A) network. In some other implementations, the wireless communications system 100 may be a 5G network, such as a new radio (NR) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1A. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1A. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink (SL). For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1 c, F1 u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N3, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHZ-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

FIG. 1B illustrates an example PSFCH occupation associated with aspects of the present disclosure. As agreed in the 3GPP RAN #1 meeting, a PSFCH transmission occupies 1 common interlace and K3 dedicated PRB, as described above. FIG. 1B shows the case with K3=1. As shown in FIG. 1B, each of the PSFCH #0, PSFCH #1, PSFCH #2, and PSFCH #3 occupies a common interlace and a dedicated PRB.

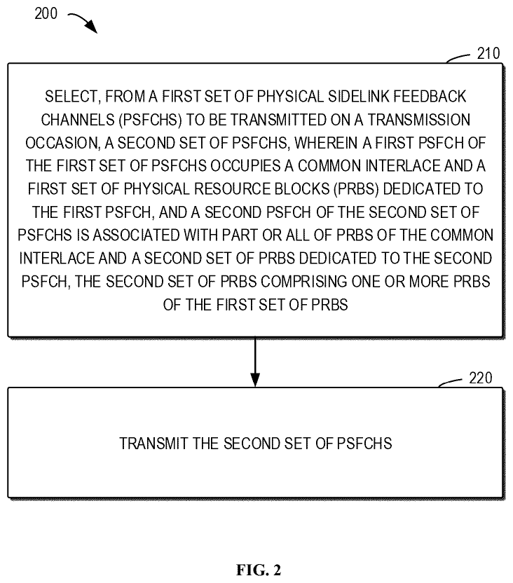

Reference is now made to FIG. 2, which illustrates a flowchart of a method 200 that supports multiple PSFCH transmissions on an unlicensed spectrum in accordance with aspects of the present disclosure. The operations of the method 200 may be implemented by a device or its components as described herein. For example, the operations of the method 200 may be performed by the UE 104 as described herein. In some implementations, the device may execute a set of instructions to control the function elements of the device to perform the described functions. Additionally, or alternatively, the device may perform aspects of the described functions using special-purpose hardware. For the purpose of discussion, the method 200 will be described with reference to FIG. 1A.

At 210, the method may include selecting, from a first set of PSFCHs to be transmitted on a transmission occasion, a second set of PSFCHs. A first PSFCH of the first set of PSFCHs may occupy a common interlace and a first set of physical resource blocks (PRBs) dedicated to the first PSFCH. A second PSFCH of the second set of PSFCHs may be associated with part or all of PRBs of the common interlace and a second set of PRBs dedicated to the second PSFCH. For example, the second PSFCH may be associated with the part of PRBs of the common interlace in a case where a PRB of the common interlace is excluded if it is determined that the PRB of the common interlace and one or more PRBs of the first set of PRBs locate within a bandwidth threshold. The second set of PRBs may comprise one or more PRBs of the first set of PRBs. The second set of PRBs may comprise one or more PRBs of the first set of PRBs.

In some embodiments where more than one dedicated PRB is (pre-) configured, e.g., 2 or 5 dedicated PRBs (i.e., the first PSFCH is configured with more than one dedicated PRB with K3 set to 2 or 5), the legacy sequence mapping on one PRB may be applied. For such K3 dedicated PRBs, the sequence mapping may be based on a repetition manner, which means that the receiving side of a PSFCH transmission may detect the PSFCH on any one of the dedicated PRBs. As the UE 104 may transmit multiple PSFCHs and each PSFCH may occupy more than one dedicated PRB, there may occur a situation where more than one dedicated PRB of different PSFCHs locate within a certain bandwidth (e.g., the same 1 MHz bandwidth), and in this case, PSD limitation should be considered. To meet the PSD requirement, the UE 104 may drop one or more dedicated PRBs from the first set of PRBs to obtain the second set of PRBs dedicated to the second PSFCH to be transmitted. It is to be understood that the first and second PSFCHs are only used as examples to describe the embodiments of the disclosure, and they may refer to any PSFCH of the first or second set of PSFCHs respectively. Likewise, the first and second sets of PRBs are only used as examples to describe the embodiments of the disclosure, and they may refer to any set of PRBs associated with a PSFCH of the first or second set of PSFCHs respectively.

In some embodiments, the UE 104 may determine the second set of PRBs based on bandwidth information of the second PSFCH. The UE 104 may drop one or more dedicated

PRBs of the second PSFCH according to the bandwidth information of the second PSFCH. If the UE 104 drops the transmission of one or more dedicated PRBs of a PSFCH, the receiving UE of the PSFCH may perform PSFCH detection on all the possible combinations of dedicated PRBs.

PRB dropping may be performed in a variety of means. In some implementations, the UE 104 may drop, from the first set of PRBs, a candidate PRB, if it determines that the candidate PRB locates within a bandwidth threshold with a PRB, determined to be transmitted, dedicated to a target PSFCH (i.e. already selected PSFCH) of the second set of PSFCHs. For example, the UE 104 may drop, from the first set of PRBs, one or more dedicated PRBs if they locate within 1 MHz bandwidth with the dedicated PRB(s) of the already selected PSFCH(s) and the dedicated PRB(s) of the already selected PSFCH(s) is the selected to-be-transmitted dedicated PRB(s).

In this case, the legacy mechanism on the selection of simultaneous PSFCH transmissions may be applied. For example, the selection from the first set of PSFCHs may be performed based on an order of priorities associated with PSFCHs of the first set of PSFCHs. The UE 104 may select from the first set of PSFCHs according to the order of priorities from higher associated priority to lower associated priority. During the selection associated with one PSFCH (e.g., the first PSFCH) of the first set of PSFCHs, the UE 104 may check whether a candidate dedicated PRB of this PSFCH locates within the bandwidth threshold (e.g., 1 MHz bandwidth) with the dedicated PRB(s) determined to be transmitted of a already selected PSFCH. If the candidate dedicated PRB locates within the bandwidth threshold with the dedicated PRB(s) determined to be transmitted of the already selected PSFCH, the UE 104 may drop the candidate dedicated PRB. If it is determined that all one or more PRBs of the first set of PRBs are dropped, the UE 104 may drop the first PSFCH. In other words, if all dedicated PRBs of the first PSFCH are dropped, the UE 104 may stop the selection procedure and transmits the already selected PSFCH(s).

In some other implementations, the UE 104 may first determine a minimum number of PRBs required for the second PSFCH. Then, the UE 104 may determine the second set of PRBs based on the minimum number of PRBs.

For example, the minimum number of PRBs required for the second PSFCH may be determined based on the coverage of the second PSFCH. Considering that the repetition of the PSFCH sequence on more than one dedicated PRB may enhance the coverage of the second PSFCH with combining gain at the reception side of the second PSFCH, so, whether the dedicated PRB(s) is dropped or how many dedicated PRBs is dropped may be based on the target coverage of the second PSFCH. As an example, the minimum number of PRBs required for the second PSFCH may be determined based on measured reference signal received power (RSRP) of a physical sidelink control channel (PSCCH) or a physical sidelink shared channel (PSSCH) associated with the second PSFCH. In this case, the measured sidelink RSRP (SL-RSRP) of the PSCCH/PSSCH associated with the second PSFCH may be used as the metric to determine the number of dedicated PRBs that may be dropped. The minimum number of PRBs required for the second PSFCH may also be determined in other ways, and the present disclosure is not limited to this regard.

Related RSRP thresholds for the measured RSRP may be (pre-) configured or pre-defined in the specification. For example, for the case with K3=5, the following four related RSRP thresholds rsrp1 to rsrp4 may be (pre-) configured or pre-defined in advance. For each of the cases defined based on the four related RSRP thresholds, the minimum number of PRBs required for the second PSFCH may be determined as follows:
For measured SL-RSRP<rsrp1, 5 dedicated PRBs are required;
For measured SL-RSRP<rsrp2, at least 4 dedicated PRBs are required;
For measured SL-RSRP<rsrp3, at least 3 dedicated PRBs are required;
For measured SL-RSRP<rsrp4, at least 2 dedicated PRBs are required;
For measured SL-RSRP>=rsrp4, at least 1 dedicated PRB is required.

In some example embodiments, the UE 104 may drop one or more PRBs from the first set of PRBs, until a number of remaining PRBs of the first set of PRBs is the minimum number of PRBs. Then, the remaining PRBs of the first set of PRBs may form the second set of PRBs. In other words, in this case, each PSFCH may be transmitted with the minimum number of dedicated PRB(s). As an example, for each PSFCH in the PSFCH transmission occasion, the UE 104 may first determine a minimum number of dedicated PRBs based on the measured SL-RSRP. Then, during the procedure of the selection of simultaneous PSFCH transmissions, the UE 104 may drop one or more dedicated PRBs of the PSFCH if the minimum number of dedicated PRBs is below K3.

In some implementations, the UE 104 may drop, from the first set of PRBs, a candidate PRB locating within a bandwidth threshold with a PRB, determined to be transmitted, dedicated to a target PSFCH of the second set of PSFCHs, until the number of remaining PRBs of the first set of PRBs is the minimum number of PRBs. As an example, the dedicated PRB(s) which locates within the same 1 MHz bandwidth with the dedicated PRB(s) of already selected PSFCH(s) may be dropped, and then, if the UE 104 still needs to further drop one or more dedicated PRBs which do not locate within the same 1 MHz bandwidth with the dedicated PRB(s) of already selected PSFCH(s), it may be up to UE implementation to determine how to further drop the one or more dedicated PRB.

In some other example embodiments, when determining the second set of PRBs of the second PSFCH, the UE 104 may drop one or more PRBs from the first set of PRBs, if a number of remaining PRBs of the first set of PRBs is not less than the minimum number of PRBs. The UE 104 may drop the second PSFCH during the selection procedure associated with the second PSFCH, if the number of remaining PRBs after dropping is less than the minimum number of PRBs.

In some implementations, the UE 104 may drop, from the first set of PRBs, a candidate PRB locating within a bandwidth threshold with a PRB, determined to be transmitted, dedicated to a target PSFCH of the second set of PSFCHs, if the number of remaining PRBs of the first set of PRBs is not less than the minimum number of PRBs. As an example, if one or more dedicated PRBs of the second PSFCH locate within the same 1 MHz bandwidth with dedicated PRB(s) of already selected PSFCH(s), the UE 104 may drop the one or more dedicated PRBs, if the remaining number of dedicated PRB(s) is not less than the minimum number of dedicated PRBs. If the remaining dedicated PRBs after dropping is less than minimum number of dedicated PRBs, the second PSFCH may not be selected.

In some other implementations, a maximum number threshold of PRBs allowed be transmitted within a bandwidth (e.g., 1 MHz bandwidth) may be configured, or pre-configured or pre-defined. For example, a parameter related to the maximum number threshold of PRBs that may be transmitted within the bandwidth (e.g., 1 MHz bandwidth) may be (pre-) configured or pre-defined. In this case, with a condition that the number of remaining PRBs of the first set of PRBs is not less than the minimum number of PRBs, the UE 104 may drop, from the first set of PRBs, a candidate PRB, if it determines that the candidate PRB locates within the bandwidth threshold with a PRB, determined to be transmitted, dedicated to a first target PSFCH of the second set of PSFCHs, and it also determines that a total number of PRBs, of the first set of PRBs, locating within the bandwidth threshold with one or more PRBs, determined to be transmitted, dedicated to one or more target PSFCHs of the second set of PSFCHs exceeds the maximum number threshold.

In some embodiments where the maximum number threshold of PRBs is configured, or pre-configured or pre-defined, dedicated PRB dropping may not be allowed, or in other words, all K3 dedicated PRBs may be transmitted without dropping. During the procedure of selection of simultaneous PSFCH transmissions, the UE 104 may select the PSFCHs of the first set of PSFCHs from higher priority to lower priority with the restriction of UE capability. In this case, during a selection associated with the first PSFCH of the first set of PSFCHs, the UE 104 may add the first PSFCH to the second set of PSFCHs, if it determines that a total number of PRBs, of the first set of PRBs, locating within a bandwidth threshold with one or more PRBs, determined to be transmitted, dedicated to one or more target PSFCHs (i.e. one or more already selected PSFCH) of the second set of PSFCHs fail to exceed a maximum number threshold. Otherwise, the UE 104 may drop the first PSFCH, if the total number of PRBs, of the first set of PRBs, locating within a bandwidth threshold with one or more PRBs, determined to be transmitted, dedicated to the one or more target PSFCHs of the second set of PSFCHs exceeds the maximum number threshold. As an example, if the total number exceeds the maximum number threshold, the UE 104 may then stop a selection procedure for the second set of PSFCHs and transmit one or more selected PSFCHs of the PSFCHs. As another example, if the total number exceeds the maximum number threshold, the UE 104 may then continue a selection associated with a further PSFCH associated with a next priority after a priority of the first PSFCH.

For instance, if the total number of dedicated PRBs of the second PSFCH locating within 1 MHz bandwidth with the PRB(s) of already selected PSFCH(s) exceeds a maximum number threshold, the UE 104 may not select the second PSFCH, otherwise the second PSFCH may be selected. If the total number reaches the maximum number threshold, the UE 104 may stop the selection and transmits the selected PSFCHs. Alternatively, the UE 104 may continue to select a further PSFCH with the next associated priority if it is not beyond the UE capability.

Then, after determining the second set of PSFCHs and the associated dedicated PRB(s) to be transmitted, as shown in FIG. 2, at 220, the method may include transmitting the second set of PSFCHs. For example, one or more PRBs dedicated to and associated with the second set of PSFCHs may be transmitted.

In some embodiments, the UE 104 may determine transmitting power for the second set of PSFCHs. Then, the UE 104 may transmit the second set of PSFCH based on the transmitting power.

In some implementations, two parameters on maximum transmitting power may be (pre-) configured or pre-defined respectively for one or more dedicated PRBs and for the common interlace, where one of the parameters (also referred to as a first parameter) on maximum transmitting power for the one or more PRBs associated with and dedicated to the second set of PSFCHs may be used to perform power control for the one or more PRBs associated with and dedicated to the second set of PSFCHs, and the other one (also referred to as a second parameter) on maximum transmitting power for the common interlace may be used to perform power control for one or more PRBs of the common interlace. In this case, the UE 104 may perform power control for the one or more PRBs associated with and dedicated to the second set of PSFCHs based on the first parameter, and perform power control for one or more PRBs of the common interlace based on the second parameter. Thus, it is allowed to guarantee the transmitting power on the one or more PRBs of the common interlace is much smaller than the transmitting power on the one or more dedicated PRB(s) associated with the second set of PSFCHs via (pre-) configurations/pre-definition.

As another example, the maximum transmitting power for the common interlace may be distributed to all of PRBs within the common interlace. In other words, the (pre-) configured or defined maximum transmitting power for the common interlace may be allocated based on the total number of PRBs within the common interlace.

As another example, considering that as specified in the agreement, when a PRB of the common interlace and a dedicated PRB locate within 1 MHz bandwidth, the transmission of the common PRB may be dropped subject to OCB requirement. Thus, in some cases, the actual transmitted PRBs of the common interlace may be less than the total number of PRBs within the common interlace, e.g., <10 or 11 PRBs. In this case, the maximum transmitting power for the common interlace may be distributed to part of PRBs within the common interlace that comprises one or more PRBs determined to be transmitted within the common interlace. In other words, the (pre-) configured or defined maximum transmitting power for the common interlace may be allocated based on the number of actual to-be-transmitted PRBs of the common interlace.

In some other implementations, a parameter (also referred to as a third parameter) on an offset of maximum transmitting power between the common interlace and the one or more PRBs associated with and dedicated to the second set of PSFCHs may be (pre-) configured or pre-defined. Then, the UE 104 may perform power control for the one or more PRBs associated with and dedicated to the second set of PSFCHs and one or more PRBs of the common interlace based on the third parameter. In this case, the (pre-) configuration or pre-definition may provide an offset value of transmitting power between the common interlace and associated dedicated PRB(s), e.g., −6 dB or −10 dB. As an example, the offset value may be (pre-) configured or pre-defined in a level of a resource block (RB) (i.e. RB level) between PRBs of the common interlace and associated dedicated PRBs. As another example, the offset value may be (pre-) configured or pre-defined in a level of a total number of RBs. In other words, the offset may be between transmitting power for the total number of PRBs of the common interlace and that for the total number of associated dedicated PRB(s). The total number of PRBs may be calculated with actual to-be-transmitted PRBs.

In some further implementations, with the consideration of PSD limitation, the transmitting power for associated dedicated PRB(s) may be limited by transmitting power for PRB(s) within the common interlace even if only one dedicated PRB is within the 1 MHz bandwidth. In this case, to overcome the IBE issue of the common interlace, the UE 104 may equally distribute transmitting power among one or more PRBs determined to be transmitted within the common interlace and one or more PRBs associated with and dedicated to the second set of PSFCHs. In other words, the transmitting power may be equally distributed among the PRBs, occupied by the second set of PSFCHs, which include PRBs determined to be transmitted within the common interlace and the associated dedicated PRBs of the second set of PSFCHs.

According to some embodiments with reference to FIG. 2, it is allowed to support multiple PSFCH transmissions on an unlicensed spectrum well. In this way, it is possible to improve the flexibility of PSFCH selection and thus the flexibility of the PSFCH transmissions and thus improve sidelink communication efficiency.

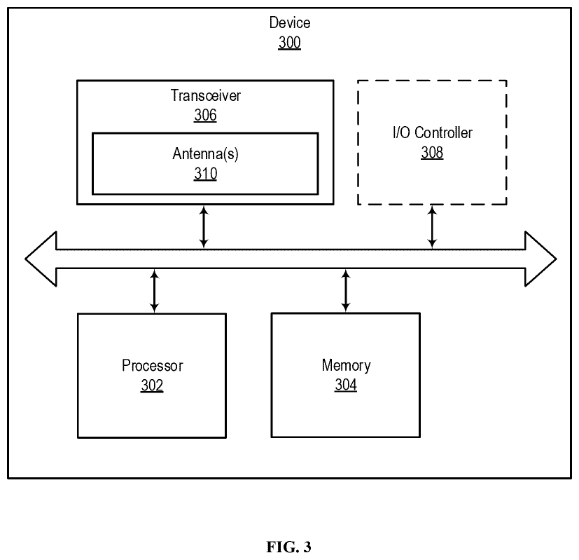

FIG. 3 illustrates an example of a device 300 that supports multiple PSFCH transmissions on an unlicensed spectrum in accordance with aspects of the present disclosure. The device 300 may be an example of the UE 104 as described herein. The device 300 may support wireless communication with one or more network entities 102, UEs 104, or any combination thereof. The device 300 may include components for bi-directional communications including components for transmitting and receiving communications, such as a processor 302, a memory 304, a transceiver 306, and, optionally, an I/O controller 308. These components may be in electronic communication or otherwise coupled (e.g., operatively, communicatively, functionally, electronically, electrically) via one or more interfaces (e.g., buses).

The processor 302, the memory 304, the transceiver 306, or various combinations thereof or various components thereof may be examples of means for performing various aspects of the present disclosure as described herein. For example, the processor 302, the memory 304, the transceiver 306, or various combinations or components thereof may support a method for performing one or more of the operations described herein.

In some implementations, the processor 302, the memory 304, the transceiver 306, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 302 and the memory 304 coupled with the processor 302 may be configured to perform one or more of the functions described herein (e.g., executing, by the processor 302, instructions stored in the memory 304).

For example, the processor 302 may support wireless communication at the device 300 in accordance with examples as disclosed herein. The processor 302 may be configured to operable to support a means for selecting, from a first set of physical sidelink feedback channels (PSFCHs) to be transmitted on a transmission occasion, a second set of PSFCHs, wherein a first PSFCH of the first set of PSFCHs occupies a common interlace and a first set of physical resource blocks (PRBs) dedicated to the first PSFCH, and a second PSFCH of the second set of PSFCHs is associated with part or all of PRBs of the common interlace and a second set of PRBs dedicated to the second PSFCH, the second set of PRBs comprising one or more PRBs of the first set of PRBs; and a means for transmitting the second set of PSFCHs.

The processor 302 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 302 may be configured to operate a memory array using a memory controller. In some other implementations, a memory controller may be integrated into the processor 302. The processor 302 may be configured to execute computer-readable instructions stored in a memory (e.g., the memory 304) to cause the device 300 to perform various functions of the present disclosure.

The memory 304 may include random access memory (RAM) and read-only memory (ROM). The memory 304 may store computer-readable, computer-executable code including instructions that, when executed by the processor 302 cause the device 300 to perform various functions described herein. The code may be stored in a non-transitory computer-readable medium such as system memory or another type of memory. In some implementations, the code may not be directly executable by the processor 302 but may cause a computer (e.g., when compiled and executed) to perform functions described herein. In some implementations, the memory 304 may include, among other things, a basic I/O system (BIOS) which may control basic hardware or software operation such as the interaction with peripheral components or devices.

The I/O controller 308 may manage input and output signals for the device 300. The I/O controller 308 may also manage peripherals not integrated into the device M02. In some implementations, the I/O controller 308 may represent a physical connection or port to an external peripheral. In some implementations, the I/O controller 308 may utilize an operating system such as iOS®, ANDROID®, MS-WINDOWS®, OS/2®, UNIX®, LINUX®, or another known operating system. In some implementations, the I/O controller 308 may be implemented as part of a processor, such as the processor 306. In some implementations, a user may interact with the device 300 via the I/O controller 308 or via hardware components controlled by the I/O controller 308.

In some implementations, the device 300 may include a single antenna 310. However, in some other implementations, the device 300 may have more than one antenna 310 (i.e., multiple antennas), including multiple antenna panels or antenna arrays, which may be capable of concurrently transmitting or receiving multiple wireless transmissions. The transceiver 306 may communicate bi-directionally, via the one or more antennas 310, wired, or wireless links as described herein. For example, the transceiver 306 may represent a wireless transceiver and may communicate bi-directionally with another wireless transceiver. The transceiver 306 may also include a modem to modulate the packets, to provide the modulated packets to one or more antennas 310 for transmission, and to demodulate packets received from the one or more antennas 310. The transceiver 306 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 310 for transmitting the amplified signal into the air or wireless medium.

A receive chain may be configured to receive signals (e.g., control information, data, packets) over a wireless medium. For example, the receive chain may include one or more antennas 310 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

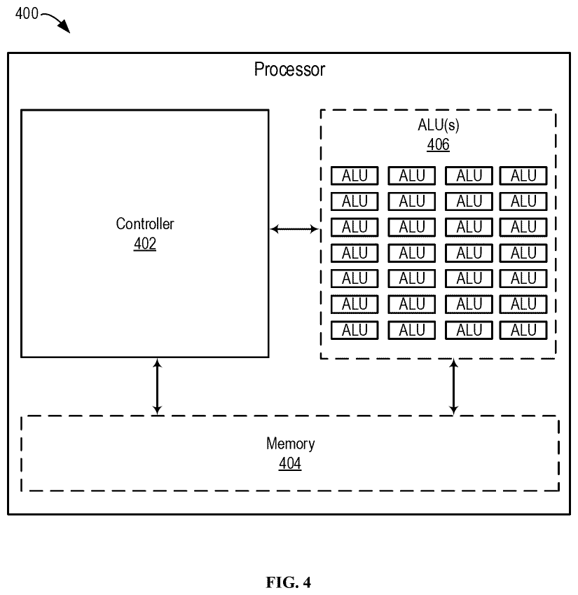

FIG. 4 illustrates an example of a processor 400 that supports multiple PSFCH transmissions on an unlicensed spectrum in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, such as L1/L2/L3 cache. Additionally, or alternatively, the processor 400 may optionally include one or more arithmetic-logic units (ALUs) 400. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations of a base station in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory address of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, arithmetic logic units (ALUs), and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, and the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 400 may be configured to support various operations in accordance with examples as described herein. In some implementations, the one or more ALUs 400 may reside within or on a processor chipset (e.g., the processor 400). In some other implementations, the one or more ALUs 400 may reside external to the processor chipset (e.g., the processor 400). One or more ALUs 400 may perform one or more computations such as addition, subtraction, multiplication, and division on data. For example, one or more ALUs 400 may receive input operands and an operation code, which determines an operation to be executed. One or more ALUs 400 be configured with a variety of logical and arithmetic circuits, including adders, subtractors, shifters, and logic gates, to process and manipulate the data according to the operation. Additionally, or alternatively, the one or more ALUs 400 may support logical operations such as AND, OR, exclusive-OR (XOR), not-OR (NOR), and not-AND (NAND), enabling the one or more ALUs 400 to handle conditional operations, comparisons, and bitwise operations.

The processor 400 may support wireless communication in accordance with examples as disclosed herein. The processor 400 may be configured to or operable to support a means for selecting, from a first set of physical sidelink feedback channels (PSFCHs) to be transmitted on a transmission occasion, a second set of PSFCHs, wherein a first PSFCH of the first set of PSFCHs occupies a common interlace and a first set of physical resource blocks (PRBs) dedicated to the first PSFCH, and a second PSFCH of the second set of PSFCHs is associated with part or all of PRBs of the common interlace and a second set of PRBs dedicated to the second PSFCH, the second set of PRBs comprising one or more PRBs of the first set of PRBs; and a means for transmitting the second set of PSFCHs.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

In summary, embodiments of the present disclosure may provide the following solutions.
Clause 1. A user equipment (UE) comprising: at least one memory; and at least one processor coupled with the at least one memory and configured to cause the UE to: select, from a first set of physical sidelink feedback channels (PSFCHs) to be transmitted on a transmission occasion, a second set of PSFCHs, wherein a first PSFCH of the first set of PSFCHs occupies a common interlace and a first set of physical resource blocks (PRBs) dedicated to the first PSFCH, and a second PSFCH of the second set of PSFCHs is associated with part or all of PRBs of the common interlace and a second set of PRBs dedicated to the second PSFCH, the second set of PRBs comprising one or more PRBs of the first set of PRBs; and transmit the second set of PSFCHs.
Clause 2. The UE of clause 1, wherein the at least one processor is further configured to cause the UE to: determine transmitting power for the second set of PSFCHs, and wherein transmitting the second set of PSFCH comprises: transmitting the second set of PSFCH based on the transmitting power.
Clause 3. The UE of clause 2, wherein determining the transmitting power for the second set of PSFCHs comprises: performing power control for one or more PRBs associated with and dedicated to the second set of PSFCHs, based on a first parameter on maximum transmitting power for the one or more PRBs associated with and dedicated to the second set of PSFCHs; and wherein the at least one processor is further configured to cause the UE to: perform power control for one or more PRBs of the common interlace, based on a second parameter on maximum transmitting power for the common interlace.
Clause 4. The UE of clause 3, wherein the maximum transmitting power for the common interlace is distributed to part or all of PRBs within the common interlace, the part of PRBs comprising one or more PRBs determined to be transmitted within the common interlace.
Clause 5. The UE of clause 2, wherein determining the transmitting power for the second set of PSFCHs comprises: performing power control for one or more PRBs associated with and dedicated to the second set of PSFCHs and one or more PRBs of the common interlace, based on a third parameter on an offset of maximum transmitting power between the common interlace and the one or more PRBs associated with and dedicated to the second set of PSFCHs.
Clause 6. The UE of clause 5, wherein a value of the offset is in a level of a resource block (RB), or in a level of a total number of RBs.
Clause 7. The UE of clause 2, wherein determining the transmitting power for the second set of PSFCHs comprises: equally distributing transmitting power among one or more PRBs determined to be transmitted within the common interlace and one or more PRBs associated with and dedicated to the second set of PSFCHs.
Clause 8. The UE of clause 1, wherein the at least one processor is further configured to cause the UE to: determine the second set of PRBs based on bandwidth information of the second PSFCH.
Clause 9. The UE of clause 8, wherein determining the second set of PRBs comprises: dropping, from the first set of PRBs, a candidate PRB, based on determining that the candidate PRB locates within a bandwidth threshold with a PRB, determined to be transmitted, dedicated to a target PSFCH of the second set of PSFCHs.
Clause 10. The UE of clause 9, wherein selecting the second set of PSFCHs comprises: during a selection associated with the first PSFCH of the first set of PSFCHs, based on determining that all one or more PRBs of the first set of PRBs are dropped, dropping the first PSFCH.
Clause 11. The UE of clause 8, wherein determining the second set of PRBs comprises: determining a minimum number of PRBs required for the second PSFCH; and determining the second set of PRBs based on the minimum number of PRBs.
Clause 12. The UE of clause 11, wherein determining the second set of PRBs comprises: dropping one or more PRBs from the first set of PRBs, until a number of remaining PRBs of the first set of PRBs is the minimum number of PRBs.
Clause 13. The UE of clause 11, wherein determining the second set of PRBs comprises: dropping one or more PRBs from the first set of PRBs, if a number of remaining PRBs of the first set of PRBs is not less than the minimum number of PRBs.
Clause 14. The UE of clause 12 or 13, wherein dropping the one or more PRBs from the first set of PRBs comprises: dropping, from the first set of PRBs, a candidate PRB, based on determining that the candidate PRB locates within a bandwidth threshold with a PRB, determined to be transmitted, dedicated to a target PSFCH of the second set of PSFCHs.
Clause 15. The UE of clause 13, wherein dropping the one or more PRBs from the first set of PRBs comprises: dropping, from the first set of PRBs, a candidate PRB, based on determining that: the candidate PRB locates within a bandwidth threshold with a PRB, determined to be transmitted, dedicated to a first target PSFCH of the second set of PSFCHs; and a total number of PRBs, of the first set of PRBs, locating within the bandwidth threshold with one or more PRBs, determined to be transmitted, dedicated to one or more target PSFCHs of the second set of PSFCHs exceeds a maximum number threshold.
Clause 16. The UE of clause 11, wherein the minimum number of PRBs required for the second PSFCH is determined based on measured reference signal received power (RSRP) of a physical sidelink control channel (PSCCH) or a physical sidelink shared channel (PSSCH) associated with the second PSFCH.
Clause 17. The UE of clause 1, wherein selecting the second set of PSFCHs comprises: during a selection associated with the first PSFCH of the first set of PSFCHs, adding the first PSFCH to the second set of PSFCHs, based on determining that a total number of PRBs, of the first set of PRBs, locating within a bandwidth threshold with one or more PRBs, determined to be transmitted, dedicated to one or more target PSFCHs of the second set of PSFCHs fail to exceed a maximum number threshold.
Clause 18. The UE of clause 1, wherein selecting the second set of PSFCHs comprises: during a selection associated with the first PSFCH of the first set of PSFCHs, dropping the first PSFCH, based on determining that a total number of PRBs, of the first set of PRBs, locating within a bandwidth threshold with one or more PRBs, determined to be transmitted, dedicated to one or more target PSFCHs of the second set of PSFCHs exceeds a maximum number threshold.
Clause 19. The UE of clause 18, wherein the selection from the first set of PSFCHs is performed based on an order of priorities associated with PSFCHs of the first set of PSFCHs, wherein selecting the second set of PSFCHs further comprises one of the following: stopping a selection procedure for the second set of PSFCHs and transmitting one or more selected PSFCHs of the PSFCHs; or continuing a selection associated with a further PSFCH associated with a next priority after a priority of the first PSFCH.
Clause 20. The UE of any of clauses 15, 17, and 18, wherein the maximum number threshold is configured, or pre-configured or pre-defined.
Clause 21. The UE of clause 1, wherein the second PSFCH is associated with the part of PRBs of the common interlace in a case where a PRB of the common interlace is excluded based on determining that the PRB of the common interlace and one or more PRBs of the first set of PRBs locate within a bandwidth threshold.
Clause 22. A method performed by a user equipment (UE), comprising: selecting, from a first set of physical sidelink feedback channels (PSFCHs) to be transmitted on a transmission occasion, a second set of PSFCHs, wherein a first PSFCH of the first set of PSFCHs occupies a common interlace and a first set of physical resource blocks (PRBs) dedicated to the first PSFCH, and a second PSFCH of the second set of PSFCHs is associated with part or all of PRBs of the common interlace and a second set of PRBs dedicated to the second PSFCH, the second set of PRBs comprising one or more PRBs of the first set of PRBs; and transmitting the second set of PSFCHs.

1. A user equipment (UE) for wireless communication, comprising:
at least one memory; and
at least one processor coupled with the at least one memory and configured to cause the UE to:
select, from a first set of physical sidelink feedback channels (PSFCHs) to be transmitted on a transmission occasion, a second set of PSFCHs, wherein a first PSFCH of the first set of PSFCHs occupies a common interlace and a first set of physical resource blocks (PRBs) dedicated to the first PSFCH, and a second PSFCH of the second set of PSFCHs is associated with part or all of PRBs of the common interlace and a second set of PRBs dedicated to the second PSFCH, and wherein the second set of PRBs comprises one or more PRBs of the first set of PRBs; and
transmit the second set of PSFCHs.

2. The UE of claim 1,
wherein the at least one processor is further configured to cause the UE to:
determine a transmitting power for the second set of PSFCHs, and
wherein, to transmit the second set of PSFCH, the at least one processor is configured to cause the UE to:
transmit the second set of PSFCH based on the transmitting power.

3. The UE of claim 2,
wherein, to determine the transmitting power for the second set of PSFCHs, the at least one processor is configured to cause the UE to:
perform power control for one or more PRBs associated with and dedicated to the second set of PSFCHs, based on a first parameter on maximum transmitting power for the one or more PRBs associated with and dedicated to the second set of PSFCHs; and
wherein the at least one processor is further configured to cause the UE to:
perform power control for one or more PRBs of the common interlace, based on a second parameter on maximum transmitting power for the common interlace.

4. The UE of claim 3, wherein the maximum transmitting power for the common interlace is distributed to part or all of PRBs within the common interlace, and wherein the part of PRBs comprising one or more PRBs determined to be transmitted within the common interlace.

5. The UE of claim 2, wherein, to determine the transmitting power for the second set of PSFCHs, the at least one processor is configured to cause the UE to:
perform power control for one or more PRBs associated with and dedicated to the second set of PSFCHs and one or more PRBs of the common interlace, based on a third parameter on an offset of maximum transmitting power between the common interlace and the one or more PRBs associated with and dedicated to the second set of PSFCHs.

6. The UE of claim 2, wherein, to determine the transmitting power for the second set of PSFCHs, the at least one processor is configured to cause the UE to:
equally distribute the transmitting power among one or more PRBs determined to be transmitted within the common interlace and one or more PRBs associated with and dedicated to the second set of PSFCHs.

7. The UE of claim 1, wherein the at least one processor is further configured to cause the UE to:
determine the second set of PRBs based on bandwidth information of the second PSFCH.

8. The UE of claim 7, wherein, to determine the second set of PRBs, the at least one processor is configured to cause the UE to:
drop, from the first set of PRBs, a candidate PRB, based on determining that the candidate PRB locates within a bandwidth threshold with a PRB, determined to be transmitted, dedicated to a target PSFCH of the second set of PSFCHs.

9. The UE of claim 8, wherein, to select the second set of PSFCHs, the at least one processor is configured to cause the UE to:
during a selection associated with the first PSFCH of the first set of PSFCHs, based on determining that all one or more PRBs of the first set of PRBs are dropped, drop the first PSFCH.

10. The UE of claim 7, wherein, to determine the second set of PRBs, the at least one processor is configured to cause the UE to:
determine a minimum number of PRBs required for the second PSFCH; and
determine the second set of PRBs based on the minimum number of PRBs.

11. The UE of claim 10, wherein, to determine the second set of PRBs, the at least one processor is configured to cause the UE to:
drop one or more PRBs from the first set of PRBs, until a number of remaining PRBs of the first set of PRBs is the minimum number of PRBs.

12. The UE of claim 10, wherein, to determine the second set of PRBs, the at least one processor is configured to cause the UE to:
drop one or more PRBs from the first set of PRBs, if a number of remaining PRBs of the first set of PRBs is not less than the minimum number of PRBs.

13. The UE of claim 12, wherein, to drop the one or more PRBs from the first set of PRBs, the at least one processor is configured to cause the UE to:
drop, from the first set of PRBs, a candidate PRB, based on determining that the candidate PRB locates within a bandwidth threshold with a PRB, determined to be transmitted, dedicated to a target PSFCH of the second set of PSFCHs.

14. The UE of claim 12, wherein, to drop the one or more PRBs from the first set of PRBs, the at least one processor is configured to cause the UE to:
drop, from the first set of PRBs, a candidate PRB, based on determining that:
the candidate PRB locates within a bandwidth threshold with a PRB, determined to be transmitted, dedicated to a first target PSFCH of the second set of PSFCHs; and
wherein a total number of PRBs, of the first set of PRBs, locating within the bandwidth threshold with one or more PRBs, determined to be transmitted, dedicated to one or more target PSFCHs of the second set of PSFCHs exceeds a maximum number threshold.

15. The UE of claim 1, wherein, to selecting the second set of PSFCHs, the at least one processor is configured to cause the UE to:
during a selection associated with the first PSFCH of the first set of PSFCHs, add the first PSFCH to the second set of PSFCHs, based on determining that a total number of PRBs, of the first set of PRBs, locating within a bandwidth threshold with one or more PRBs, determined to be transmitted, dedicated to one or more target PSFCHs of the second set of PSFCHs fail to exceed a maximum number threshold.

16. The UE of claim 1, wherein, to select the second set of PSFCHs, the at least one processor is configured to cause the UE to:
during a selection associated with the first PSFCH of the first set of PSFCHs, drop the first PSFCH, based on determining that a total number of PRBs, of the first set of PRBs, locating within a bandwidth threshold with one or more PRBs, determined to be transmitted, dedicated to one or more target PSFCHs of the second set of PSFCHs exceeds a maximum number threshold.

17. The UE of claim 16, wherein the selection from the first set of PSFCHs is performed based on an order of priorities associated with PSFCHs of the first set of PSFCHs, and wherein, to select the second set of PSFCHs, the at least one processor is configured to cause the UE to:
stop a selection procedure for the second set of PSFCHs and transmitting one or more selected PSFCHs of the PSFCHs; or
continue a selection associated with a further PSFCH associated with a next priority after a priority of the first PSFCH.

18. The UE of claim 16, wherein the maximum number threshold is configured, or pre-configured, or pre-defined.

19. The UE of claim 1, wherein the second PSFCH is associated with the part of the PRBs of the common interlace when a PRB of the common interlace is excluded based on determining that the PRB of the common interlace and one or more PRBs of the first set of PRBs locate within a bandwidth threshold.

20. A method performed by a user equipment (UE), the method comprising:
selecting, from a first set of physical sidelink feedback channels (PSFCHs) to be transmitted on a transmission occasion, a second set of PSFCHs, wherein a first PSFCH of the first set of PSFCHs occupies a common interlace and a first set of physical resource blocks (PRBs) dedicated to the first PSFCH, and a second PSFCH of the second set of PSFCHs is associated with part or all of PRBs of the common interlace and a second set of PRBs dedicated to the second PSFCH, the second set of PRBs comprising one or more PRBs of the first set of PRBs; and
transmitting the second set of PSFCHs.
